(19) United States
(12) Patent Application Publication
(10) Pub. No.: US 2004/0173438 A1
(43) Pub. Date: Sep. 9, 2004

(54) Trolley-less overhead conveyer system

(75) Inventor: Richard G. Ursitti, Pasadena, CA (US)

Correspondence Address: Richard H. Zaitlen, PILLSBURY WINTHROP LLP, Suite 2800, 725 South Figueroa Street, Los Angeles, CA, 90017, US

(73) Assignee: SDI Industries, Inc., Pacoima, CA

(21) Appl. No.: 10/384,086

(22) Filed: Mar. 7, 2003

(51) Int. Cl. B65G 47/60

(52) U.S. Cl. 198/465.4; 198/369.1

(57) ABSTRACT

A system is provided for the transportation of products on hangers. The system is designed to have a high throughput. The system includes a series of interconnected rails, a movable train, a pusher dog assembly and a track switch. The track switch may be designed for the induction of products on hangers onto the series of interconnected rails. The pusher dog assembly may be engaged to the movable train, which may be disposed adjacent to the series of interconnected rails. The system may be configured to effectuate the movement of hangers along the series of interconnected rails through the action of the pusher dog assembly. A method for transporting products on hangers is also provided.

### FIELD OF THE INVENTION

The present invention relates to overhead conveyer systems for the movement of hanging products. In particular, the invention relates to overhead conveyer systems that eliminate the need for product trolleys.

### BACKGROUND OF THE INVENTION

Overhead conveyer systems are well known in the present state of the art. The systems are used for transporting various types of merchandise, including hanging garments and other products, through manufacturing, warehousing and distribution facilities. Typical overhead conveyer systems are “power and free” systems that push heavy, metal trolleys along a track system. The trolleys carry loads of products, such as garments on hangers (“GOH”).

Power and free conveyer systems employ a system of two, parallel tracks; an upper power track and a lower free track are incorporated. The upper track generally includes a drive chain that engages a component of the trolley, while the trolley's wheels are designed to ride within the free track. The load supported by the trolley (e.g., GOH) is most often suspended below the level of the free track. The drive chain commonly includes a pusher dog that extends downward from the drive chain and engages a part of the trolley that protrudes above the level of the free track. A pusher dog is, generally, a projection that engages and pushes loads along a track or conveyer system. Movement of the trolley is thus accomplished by the mechanized action of the pusher dog on the protruding trolley part.

There are many instances of power and free conveyer systems in the present state of the art, including several references to pusher dogs. U.S. Pat. No. 6,367,612 to Dosso et al. and U.S. Pat. No. 6,308,637 are recent examples. Both of these patents are directed to pusher dog variants that are designed to accomplish the movement of the aforementioned trolleys along a parallel track system. However, references to pusher dogs or to conveyer systems that are adapted for operation without the use of trolleys are significantly less common.

Power and free overhead conveyer systems are often used in conjunction with high speed hanging garment sorters in the processing of GOH. In such an arrangement, GOH may be uploaded into a power and free system in the receiving area of a warehousing or distribution facility. The power and free system may then be used to transport single units or batches of GOH to the induction stations of the high speed garment sorters in a particular sequence or pattern. The high speed sorters are then used to separate the units or batches of GOH according to criteria such as size, style, color or shipment destination.

The use of power and free overhead conveyer systems that incorporate garment trolleys to move GOH has several disadvantages. High speed garment sorters have a potential throughput of at least 12,000 units per hour. Power and free systems cannot deliver GOH at a matching rate. While power and free systems may be able transport up to 200 garments per minute past a given point, the garment trolleys must be manually offloaded before the GOH can be transferred to the high speed sorters, thus reducing the delivery rate drastically. Therefore, the use of power and free conveyer systems in conjunction with high speed sorters effectively starves the sorters and forces them to run below capacity. This represents an inefficient use of resources and reduces the overall productivity of facilities.

The garment trolleys themselves also present various difficulties. Trolleys represent an added expense for any facility, both in purchase and maintenance costs. Also, conveyer systems incorporating trolleys can be noisy to operate. Further, additional costs are often incurred by users of power and free systems since they must also install a return system for empty trolleys (i.e., so that the trolleys can be conveyed to their starting position once the garments have been manually transferred from the trolleys to the high speed sorters). Finally, the above-mentioned manual offload of garment trolleys from power and free systems is physically demanding and can result in personal injury. The low efficiency of power and free systems and the physically demanding aspect of their use results in high labor costs.

The existing art is therefore not suitable for the task of moving large volumes of GOH or other products in a cost-effective and efficient manner. A high capacity conveyer system that does not incorporate trolleys is desired.

### BRIEF DESCRIPTION OF THE DRAWINGS

FIG. 1 is a side perspective view of a rail component in accordance with an embodiment of the present invention.

FIGS. 2a-c illustrate an enclosed track in accordance with an embodiment of the present invention. FIG. 2a is a side perspective view thereof. FIG. 2b is a side perspective, cut-away view of an interior of the enclosed track. A power chain and pusher dog assemblies are shown. FIG. 2c is another side perspective view of the enclosed track. Brackets and support elements are depicted, along with a rail component and lower portions of pusher dog assemblies.

FIGS. 3a-b illustrate a pusher dog assembly in accordance with an embodiment of the present invention. FIG. 3a is a side perspective view thereof. FIG. 3b is a side perspective view of a pusher dog pad.

FIGS. 4a-b are top perspective views of track switches in accordance with an embodiment of the present invention. The figures are drawn in view-through style to allow visualization of various parts. FIG. 4a depicts a track switch designed to induct products on hangers into a trolley-less overhead conveyer system of the present invention from three different directions. FIG. 4b depicts a track switch designed to facilitate the exit of products on hangers from a trolley-less overhead conveyer system of the present invention to one of three different delivery directions.

FIGS. 5a-c illustrate a flexible switch arm in accordance with an embodiment of the present invention. FIG. 5a is a side perspective view thereof. FIG. 5b is a perspective view of the flexible switch arm from above. FIG. 5c is a side perspective view of the flexible switch arm engaged to two rail components.

FIG. 6 is a side perspective view of a hook assembly in accordance with an embodiment of the present invention.

FIG. 7 is a top perspective view of a system for transporting products on hangers in accordance with an embodiment of the present invention.

### DETAILED DESCRIPTION

It has been discovered that the processing of GOH or other products on hangers can best be accomplished through the use of a trolley-less overhead conveyer system. A trolley-less overhead conveyer system in accordance with the present invention may include a series of interconnected rails or rail components whose length and contour may be adapted to the requirements of the facility where they are to be installed. The series of interconnected rails or rail components may include an elongated member or metal extrusion and a plastic member or extrusion that is designed to fit over the elongated member or metal extrusion.

The trolley-less overhead conveyer system may also include an enclosed track, running parallel to and above the series of interconnected rails or rail components, which may house a movable train or power chain. The movable train or power chain may be mounted with pusher dog assemblies that extend downward from the movable train or power chain, towards the series of interconnected rails or rail components. Track switches that provide for the transfer of GOH or other products on hangers onto, or off of, the series of interconnected rails or rail components may also be included. The track switches may also incorporate flexible switch arms, designed to facilitate the movement of components of the track switches. Finally, hook assemblies that mediate the transfer of GOH or other products on hangers from the trolley-less overhead conveyer system to further processing steps may also be included.

The various components of a trolley-less overhead conveyer system in accordance with the present invention may be suspended above a facility floor, using brackets and support members, at a height that allows GOH or other products on hangers to hang freely from the series of interconnected rails or rail components and that provides operators with easy access. GOH or other products on hangers may be inducted into the system at track switches and then may be conveyed along the series of interconnected rails or rail components by the pusher dog assemblies. At another track switch, GOH or other products on hangers may then be transferred to a hook assembly, where conveyer hooks pick up GOH or other products on hangers and mediate induction into high speed hanging garment sorters. Track switches and hook assemblies may be positioned outside the parallel course of the series of interconnected rails or rail components and enclosed track.

As discussed in more detail below, various different materials and component designs may be suitable for use in association with the present invention. Materials may be chosen and components may be designed to achieve the goal of seamlessly moving GOH or other products on hangers quickly, efficiently, and cost-effectively through various processing steps. Various embodiments of the present invention may be used in garment manufacturing, warehousing and distribution operations. For example, one embodiment may be used in a garment distribution facility to deliver large quantities of GOH to high speed hanging garment sorters. In such an installation, GOH may be inducted into a trolley-less overhead conveyer system at a track switch in a receiving area, it may then be conveyed along a series of interconnected rails or rail components by pusher dog assemblies, it may then be delivered to a hook assembly at another track switch and it then may be inducted into a high speed hanging garment sorter. The high speed sorter may then separate the GOH by, inter alia, shipment destination and may deliver the GOH to suitable sections of a shipping area. One skilled in the art will realize that the trolley-less overhead conveyer system of the present invention may be equally easily adapted to a manufacturing or a warehousing facility, or any other facility for the processing of GOH or other products on hangers.

The trolley-less overhead conveyer system of the present invention may accomplish the movement of GOH without encountering the difficulties of other known overhead conveyer systems. Specifically, the trolley-less system may operate at a capacity (in terms of garments/minute moved past a given point) that more closely matches the capacity of high speed hanging garment sorters, thus preventing the sorters from getting starved and increasing overall facility throughput. A trolley-less overhead conveyer system in accordance with the present invention may transport GOH at a rate of 500 garments per minute past a given point, thus ensuring a constant feed of garments to high speed sorters that operate at a capacity of 12,000 units per hour or more. Thus, the system of the present invention may use resources (such as high speed sorters) more efficiently and may increase the productivity of facilities.

Furthermore, the system of the present invention operates without garment trolleys, thus solving many of the problems presented by known power and free overhead conveyer systems. The system does not require manual offload of trolleys from a conveyer system or manual transfer of GOH from the conveyer system to high speed hanging garment sorters (as required by power and free systems). Instead, seamless operational transfer from the trolley-less overhead conveyer system to the high speed sorters may be provided through the use of the hook assemblies. The seamless transfer of GOH contributes to the increased capacity of the present system over typical power and free conveyer systems. In addition, costs associated with the purchase and maintenance of trolleys and with the installation of trolley return systems are fully eliminated. Finally, labor costs may be saved since operators of the present system need not engage in the physically demanding work of offloading trolleys and transferring GOH and will likely be exposed to a lower rate of personal injuries. Thus, the trolley-less overhead conveyer system of the present invention accomplishes the movement of GOH through various processing steps in manufacturing, warehousing and distribution facilities in a quick, efficient and cost-effective manner when compared to known power and free conveyer systems.

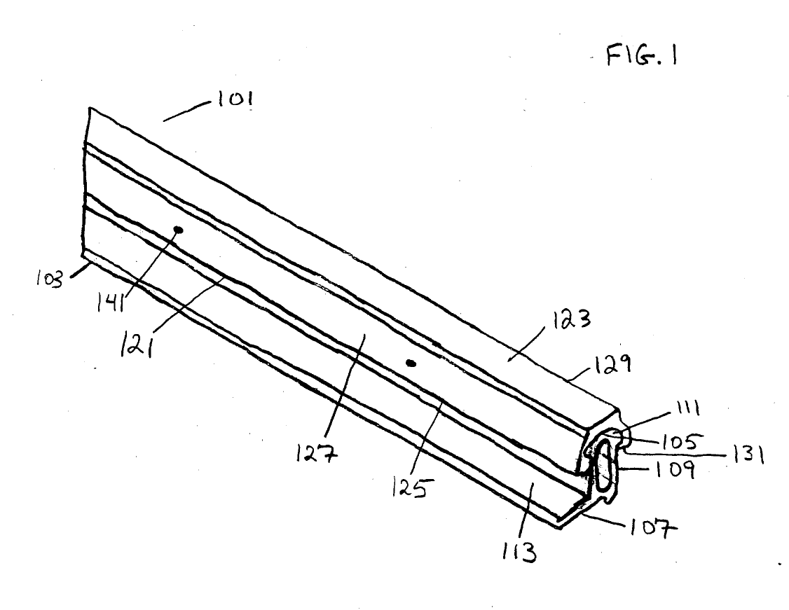

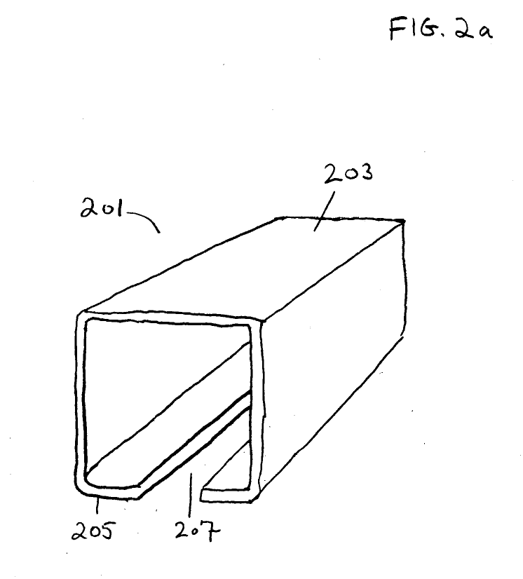

As shown in FIG. 1a, one aspect of the trolley-less overhead conveyer system of the present invention may be embodied in a rail component 101 that may be designed to accommodate the transportation of GOH. The rail component 101 may include a metal extrusion 103 and a plastic extrusion 121, with the plastic extrusion 121 being designed to snap onto the metal extrusion 103. The metal extrusion 103 may be constructed of aluminum. One skilled in the art will realize that the metal extrusion 103 may also be constructed of alternate metals. The metal extrusion 103 may have a top surface 105 and a bottom surface 107 and may include a main body section 109, a cap section 111, and a shelf section 113. The main body section 109 may be roughly oval in shape. One skilled in the art will realize that alternate shapes are possible for the main body section 109, including, but not in any way limited to, a square, a rectangle or a circle. The cap section 111 may be designed in the shape of a partial oval with a larger cross section than the main body section 109, but it will be readily apparent that it may also be designed in any shape suitable for its designated purpose. Accordingly, the cap section 111 of the metal extrusion 103 may be shaped to accommodate a close fit between the top surface 105 of the metal extrusion 103 and the plastic extrusion 121. The shelf section 113 may extend from the bottom 107 of one side of the metal extrusion 103 and may be adapted for the purpose of supporting the rail component 101 with brackets or other support members in a facility installation.

The rail component 101 may also include a plastic extrusion 121 that may be designed to snap onto the metal extrusion 103. The plastic extrusion 121 may be constructed of an oil-filled, ultra-high molecular weight polyethylene, which provides a highly slippery surface suitable for the relatively friction-free, rapid movement of hangers. One skilled in the art will realize that the plastic extrusion 121 may also be constructed of alternate materials including, but not in any way limited to hardened teflon, as long as the alternate materials provide for the rapid, relatively friction-free movement of hangers. The oil-filled plastic of the plastic extrusion 121 may include an additive that confers UV-light resistance on the plastic extrusion 121, the additive being present to prevent crumbling or other damage to the plastic extrusion 121 upon exposure to sunlight or other sources of UV radiation. The additive that confers UV-light resistance on the plastic extrusion 121 may be carbon. One skilled in the art will realize that alternate additives are possible, as long as the alternate additives confer UV-light resistance on the plastic extrusion and do not significantly hinder the rapid, relatively friction-free movement of hangers on the plastic extrusion 121.

The plastic extrusion 121 may have a top 123 and a bottom 125 and may include a main housing section 127, a flat lid section 129 positioned at the top 123 of the plastic extrusion 121, and flanges 131. The main housing section 127 may be designed roughly in the shape of a partial oval, with a larger cross section than the cap section 111, but it will be readily apparent that it may also be designed in any shape that allows the plastic extrusion 121 to fit closely onto the top surface 105 of the metal extrusion 103. For example, if the main body section 109 and cap section 111 of the metal extrusion 103 are designed with a circular cross-section, then the main housing section 127 of the plastic extrusion 121 may also be designed with a circular cross-section. The flat lid section 129 may be designed with roughly right-angled edges, so as to deter the slippage of garment hangers from the rail component 101. The flanges 131 may be designed to fit underneath the cap section 111 of the metal extrusion 103, thus allowing the plastic extrusion 121 to snap into place over the top surface 105 of the metal extrusion 103 and ensuring a stable fit between the plastic extrusion 121 and the metal extrusion 103.

The plastic extrusion 121 may be further secured to the metal extrusion 103 with rivets 141. It will be readily apparent to one skilled in the art that the rivets 141 are not necessary to the proper functioning of the rail component 101; the snap-on design of the plastic extrusion 121 and the metal extrusion 103 may provide a sufficiently secure fit in the absence of the rivets 141.

The rail component 101 may be designed to accommodate a plurality of designs of plastic and metal hangers. Thus, the shelf section 113 may only extends from one side of the metal extrusion 103, and the plastic extrusion 121 may have a small enough cross section so that a plurality of known hanger heads will fit comfortably. Further, the rail component 101 may be designed so that hangers will run along the side of the plastic extrusion 121 (and of the rail component 101 in general) opposite to the shelf section 113 of the metal extrusion 103.

The construction of the rail component 101 may provide for more rapid transportation of GOH when compared to other known rail systems and to traditional power and free conveyer systems. The slippery surface of the plastic extrusion 121 may contribute to the increased GOH capacity of a trolley-less overhead conveyer system according to the present invention as compared to traditional power and free conveyer systems. In addition, the surface design of the plastic extrusion 121, which may allow for the unhindered transport of hangers along the rail component 101, along with the absence of trolleys, may result in the trolley-less overhead conveyer system being much quieter to operate than conventional power and free systems.

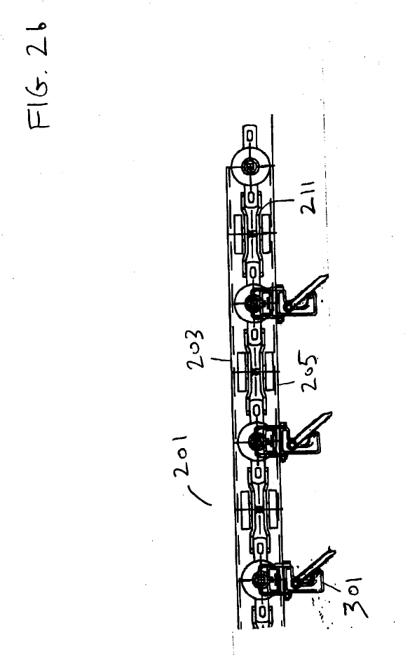

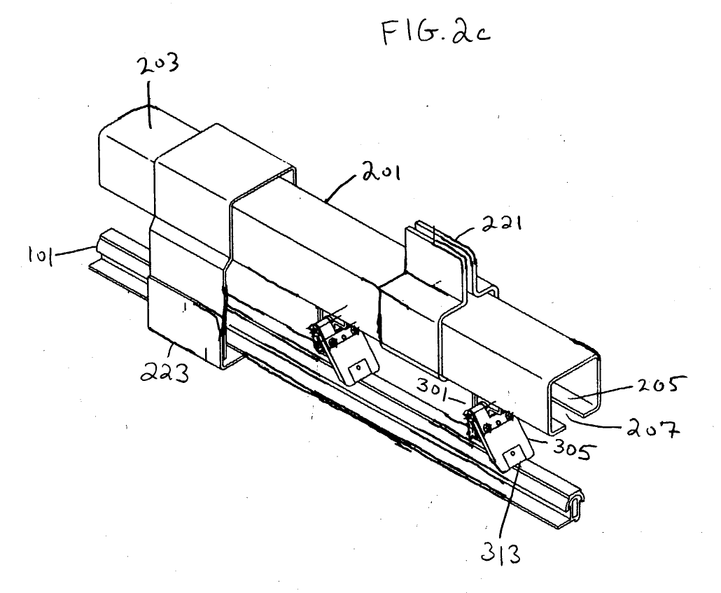

As shown in FIG. 2a, another aspect of the trolley-less overhead conveyer system of the present invention may be embodied in an enclosed track 201. The enclosed track 201 may be roughly square in shape and may have a top 203 and a bottom 205. The enclosed track 201 may be constructed of steel, although it will be readily apparent to one skilled in the art that the enclosed track may be constructed of alternate materials. The enclosed track 201 may include a central opening 207 in its bottom 205 that may extend along the length of the enclosed track 201. The opening 207 may be designed to allow a pusher dog assembly 301 (as described in more detail below) to protrude from the enclosed track 201 and extend downward toward the rail component 101, adjacent to which it may contact a hanger or a plurality of hangers and push said hanger or plurality of hangers along the rail component 101.

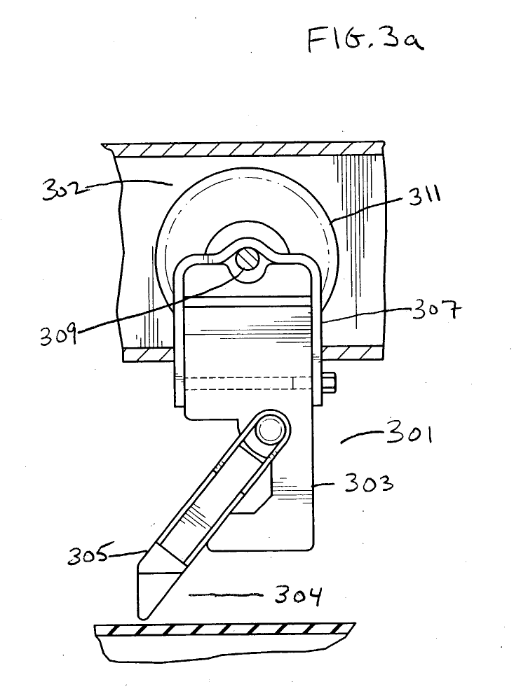

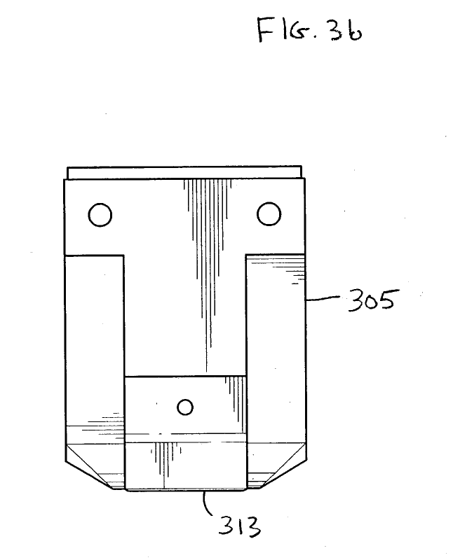

As shown in FIG. 2b, the enclosed track 201 may house a power chain 221 that may run along the length of the enclosed track 201. The power chain 211 may be engaged to multiple pusher dog assemblies 301 in accordance with an embodiment of an aspect of the present invention. As depicted in FIGS. 3a-b, the pusher dog assemblies 301 may include a top end 302, a bottom end 304, pusher dog body 303 disposed near the top end 302, a pusher pad 305 disposed near the bottom end 304, a mounting strap 307, an axle 309 and wheels 311. The pusher pad 305 may be constructed of urethane, polyurethane or glass-filled nylon, although one skilled in the art will realize that alternate materials are possible. The pusher pad 305 may further include a stainless steel tip 313, designed to ensure proper contact between the pusher pad 305, and hangers or the plastic extrusion 121 of the rail component 101. The pusher dog assemblies 301 may be configured such that the wheels 311, axle 309, and parts of the mounting strap 307 and pusher dog body 303 are housed within the enclosed track 201. The pusher dog assemblies 301 may be further configured such that the wheels 311 of the individual pusher dog assemblies 301 run along an inner side of the bottom 205 of the enclosed track 201, on either side of the central opening 207. The pusher dog assemblies 301 may be further configured such that the pusher pad 305, and parts of the mounting strap 307 and pusher dog body 303 protrude from the enclosed track 201 and extend downward toward the rail component 101.

As shown in FIG. 2c, a trolley-less overhead conveyer system in accordance with the present invention may include a rail component 101 and an enclosed track 201 that run parallel to each other, with the enclosed track 201 positioned above the rail component 101. Brackets 221 and support members 223 may be employed for suspending the rail component 101 and enclosed track 201 of the system above the floor of a facility. The pusher dog assemblies 301 may protrude from the enclosed track 201 and extend towards the rail component 101 so that the stainless steel tip 313 of the pusher pad 305 is positioned directly above the rail component 101, while still maintaining a desired clearance between the pusher pad 305 and the rail component 101. The desired clearance between the pusher pad 305 and the rail component 101 may be that which allows the pusher pad 305 to remain unengaged with the rail component 101 when the pusher pad 305 is not in contact with a hanger, but that which also allows the pusher pad 305 to contact the rail component 101 when the pusher pad 305 does engage a hanger and push it along the rail component 101.

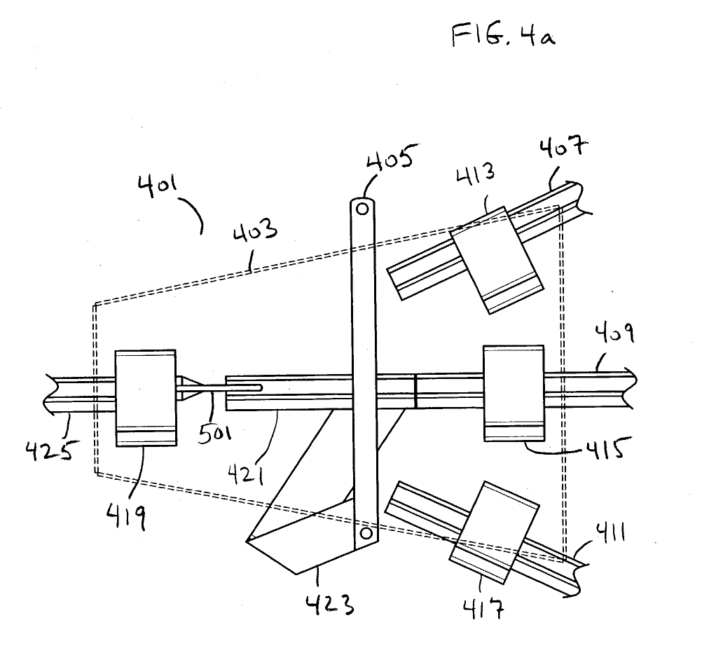

As depicted in FIGS. 4a-b, another aspect of the trolley-less overhead conveyer system of the present invention may be embodied in a track switch 401. The track switch 401 may include an upper plate 403 and a switching mechanism 405. The track switch 401 may be configured for the induction of GOH into a trolley-less overhead conveyer system, for the transfer of GOH to a hook assembly 601 (as described in more detail below) or simply for changing the direction of GOH movement within a trolley-less overhead conveyer system.

In one embodiment of a track switch 401 in accordance with the present invention, as illustrated in FIG. 4a, the track switch 401 may be configured for the induction of GOH into a trolley-less overhead conveyer system. The track switch 401 may be further configured to induct GOH into the conveyer system from three different directions. Accordingly, three induction sections of rail component 407, 409, and 411 may be provided that are positioned separately from the parallel arrangement of rail component 101 and enclosed track 201 that was described above. GOH may be manually or mechanically loaded onto any of the separate induction sections of rail component 407, 409, and 411. The separate sections of rail component 407, 409, and 411 may be supported by induction support members 413, 415, and 417 that are engaged to the upper plate 403. The track switch 401 may further include an exit section of rail component 425 that is contiguous with the parallel arrangement of rail component 101 and enclosed track 201 described above. The exit section of rail component 425 may be supported by an exit support member 419 and may be joined by a flexible switch arm 501 (as described in more detail below) to a movable section of rail component 421, which may be supported by a movable support member 423.

The movable support member 423 may be joined to the switching mechanism 405 such that actuation of the switching mechanism 405 moves the movable section of rail component 421 into a position that is adjacent to one of the three induction sections of rail component 407, 409, and 411. The track switch 401 may be configured such that the flexible switch arm 501 allows for this movement of the movable section of rail component 421 while keeping the movable section of rail component 421 joined to the exit section of rail component 425. Thus, GOH may be loaded onto any of the three induction sections of rail component 407, 409, and 411 and then may be directed onto the exit section of rail component 425 through the actuation of the switching mechanism 405. The GOH may then be transported from the exit section of rail component 425 onto the rail component 101, where the pusher pad 305 may engage the GOH and transport it along the rail component 101. This present embodiment of the track switch 401 allows for GOH that has been loaded onto any of three different induction sections of rail component 407, 409, and 411 to be inducted into a trolley-less overhead conveyer system. One skilled in the art will realize that several different configurations of track switches are possible including, but not in any way limited to, two-way and four-way track switches and track switches that allow GOH to exit a trolley-less overhead system rather than provide for the induction of GOH into such a system. For example, a track switch 430 that is designed to facilitate the exit of garments on hangers from a trolley-less overhead conveyer system (as depicted in FIG. 4b) may include a similar arrangement of parts to that of the track switch 401 described in detail above (depicted in FIG. 4a), except for the fact that the track switch 430 may include one induction section of rail component 431 that is contiguous to the rail component 101 and three exit sections of rail component 433, 435 and 437. Such a track switch 430 would be designed to facilitate the exit of garments on hangers from a trolley-less conveyer system and deposit the garments on hangers in one of three alternate delivery locations. In such an arrangement, GOH may be transported along the rail component 101 through the action of the pusher pad 305 until it reaches the induction section of rail component 431 of the track switch 430. GOH may then be directed onto one of the three exit sections of rail component 433, 435 and 437 through the actuation of the switching mechanism 405.

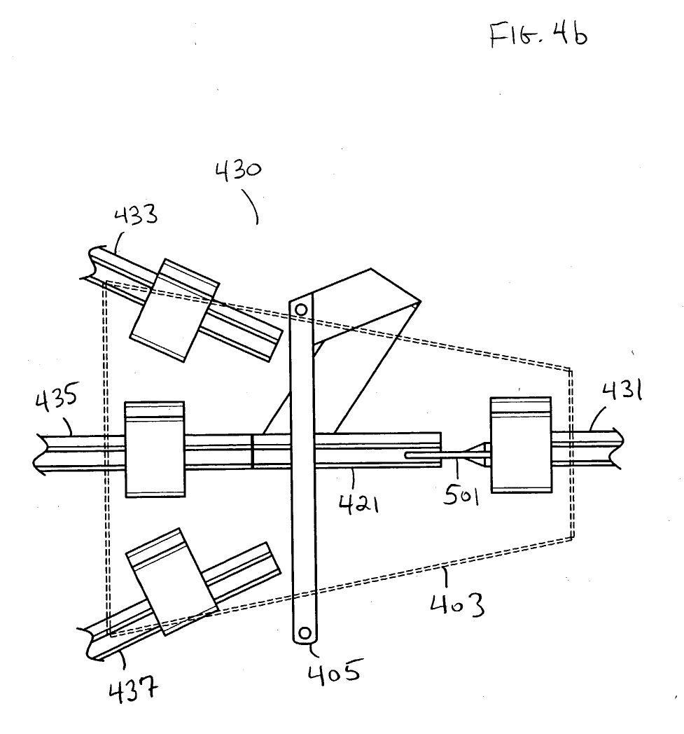

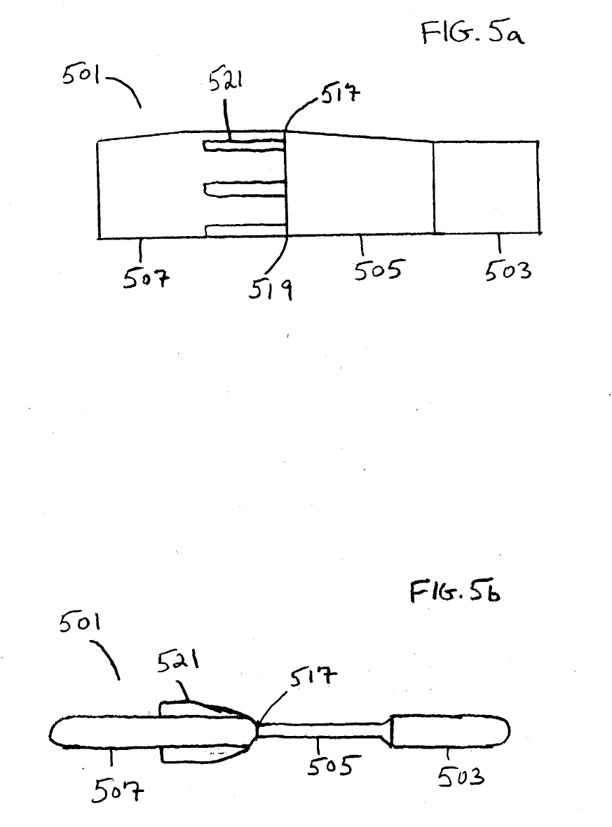

As depicted in FIGS. 5a-c, another aspect of the trolley-less overhead conveyer system of the present invention may be embodied in a flexible switch arm 501, having a top 517 and a bottom 519. As indicated above, the flexible switch arm 501 may be used to join two sections of rail component 101, such as, but in no way limited to, the movable section of rail component 421 and the exit section of rail component 425 of the track switch 401 (e.g., FIG. 4a). One skilled in the art will realize that the use of the flexible switch arm 501 is not limited to the track switch 401; the flexible switch arm 501 may be used at any location where it is desirable to join two sections of rail component 101 together. The flexible switch arm 501 may be designed such that hangers may be transported along one of the two joined sections of rail component 101, may continue to be transported along the top 517 of the flexible switch arm 501, and then may continue to be transported along the other of the two joined sections of rail component 101.

In one embodiment of a flexible switch arm 501 in accordance with the present invention, the flexible switch arm may include a leading portion 503, a flexible portion 505 and a tail portion 507. The leading portion 503 and the tail portion 507 may be designed to engage sections of rail component 101. Accordingly, a leading section of rail component 509 and a tail section of rail component 511 may be designed with a leading slot 513 and a tail slot 515, respectively, the slots 513, 515 being designed to accommodate a tight fit between the leading 503 and tail 507 portions of the flexible switch arm 501 and the leading 509 and tail 511 sections of rail component. The leading 513 and tail 515 slots may penetrate both the plastic extrusion 121 and the metal extrusion 103 of the leading section of rail component 509 and the tail section of rail component 511. The flexible switch arm 501 may be further secured to the leading and tail sections of rail component 509, 511 with rivets 523. The flexible portion 505 may be designed with an uphill contour on its top edge, such that the flexible portion has a higher profile near the tail portion 507 than it does near the leading portion 503. The uphill contour of the flexible portion 505 may assist in carrying garment hangers over a joint that is created when two sections of rail component 101 are joined by a flexible switch arm 501. The flexible switch arm may also include fins 521, disposed on the tail portion 507 of the flexible switch arm 501, which may prevent the tail section of rail component 511 from being struck by hangers.

The flexible switch arm 501 may be constructed of nylon. One skilled in the art will realize that a flexible switch arm in accordance with the present invention may also be constructed of alternate materials including, but not in any way limited to, polypropylene and rubber. The flexible switch arm 501 may be designed to facilitate a change in direction of GOH flow of up to 45° and construction materials may be chosen to provide the flexibility required for facilitating such a change in direction.

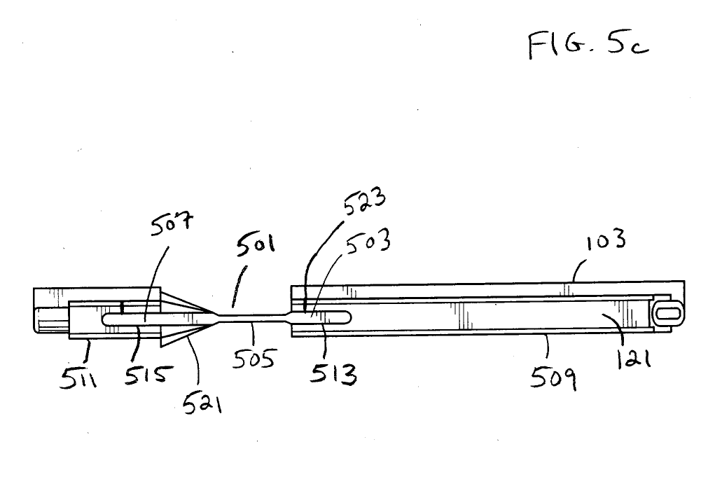

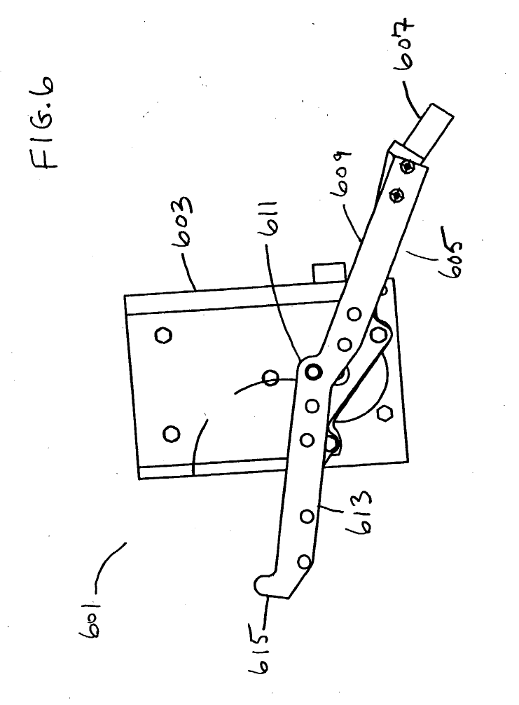

As shown in FIG. 6, another aspect of the trolley-less overhead conveyer system of the present invention may be embodied in a hook assembly 601. The hook assembly 601 may include an attachment housing 603, a hook arm 605 and a rail component adapter 607. The hook arm 605 may further include a receiving portion 609, a dividing bridge 611, an offloading portion 613 and a pick up shoe 615. The various parts of the hook assembly 601 may be constructed of steel, although one skilled in the art will realize that the hook assembly 601 may be constructed of alternate materials.

The hook assembly 601 may mediate the transfer of GOH from a trolley-less overhead conveyer system to a high speed hanging garment sorter. GOH may exit the parallel arrangement of rail component 101 and enclosed track 201 described above at a track switch 430 (e.g. FIG. 4b) that is contiguous to the rail component 101. GOH may then travel down a sloping section of rail component that is disposed contiguously to at least one of the three exit sections of rail component 433, 435 and 437, said sloping section of rail component being designed to engage with the rail component adapter 607. GOH may then travel past the engagement point of the sloping section of rail component and the rail connecting adapter 607, down the length of the hook arm 605, pausing at the dividing bridge 611 and then arriving at the pick up shoe 615. Transfer of individual garment hangers to the high speed garment sorter may be accomplished by a rotating pawl mechanism that raises the garment hangers above the pick up shoe 615 so that the garment hangers may be engaged by carry hooks of the high speed sorter. The movement of the rotating pawl may be synchronized with the arrival of each carry hook so that garment hangers are inducted into the high speed sorter with a high degree of precision (i.e., without garment hangers falling to the facility floor). The design of the hook assembly 601, and its integration with a trolley-less overhead conveyer system in accordance with the present invention and a high speed hanging garment sorter, may provide for seamless transfer of GOH from the trolley-less system to the high speed sorter. This may contribute to the marked increase in speed and efficiency of trolley-less overhead conveyer systems of the present invention when compared to conventional power and free systems. The absence of trolleys and the automated transfer of GOH from conveyer system to high speed sorter saves material and labor costs and matches the GOH capacity of the trolley-less overhead conveyer system with that of known high speed garment sorters.

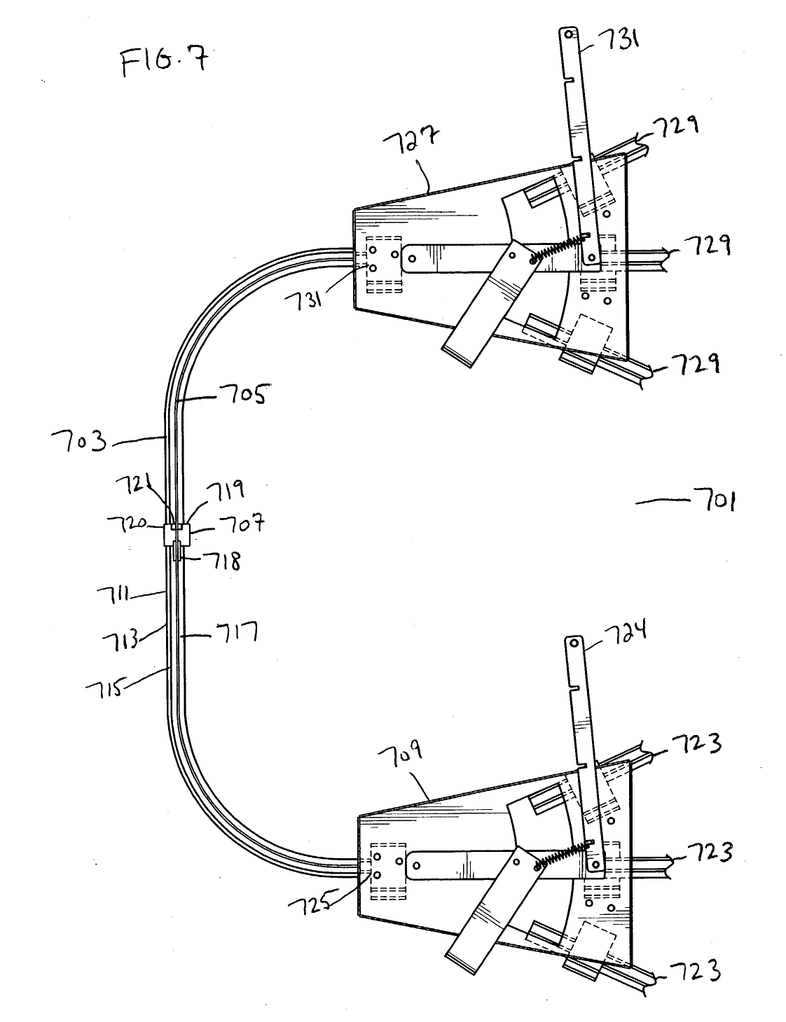

As shown in FIG. 7, one embodiment of the present invention may be a system for transporting products on hangers 701. The system 701 may include a series of interconnected rails 703, a movable train 705, a pusher dog assembly 707 and a track switch 709. The series of interconnected rails 703 may further include an elongated member 711 having a base 713 and a top 715, and a plastic member 717. The plastic member 717 may be disposed on and joined to the top of the elongated member 711 and may be configured to facilitate the movement of hangers along the length of the plastic member 717. The plastic member 717 may be constructed of oil-filled, ultra-high molecular weight polyethylene (said construction facilitating ease of hanger movement) and may contain an additive that confers UV light resistance on the plastic member 717. The additive that confers UV-light resistance on the plastic member 717 may be carbon, although one skilled in the art will realize that alternate additives are possible. One skilled in the art will also realize that the plastic member may also be constructed of alternate materials, including, but not in any way limited to hardened teflon.

The pusher dog assembly 707 may be joined to the movable train 705 and may extend toward the plastic member 717. The pusher dog assembly 707 may be configured to selectively engage hangers and to push hangers along the series of interconnected rails 703. The pusher dog assembly 707 may further include a top end 718, a bottom end 720 and a pusher pad 719 disposed at the bottom end. The pusher pad 719 may be constructed of urethane, polyurethane or glass-filled nylon, although one skilled in the art will realize that alternate materials are possible. The pusher pad 719 may further include a stainless steel tip 721, said stainless steel tip 721 being configured to improve the engagement of the pusher pad 719 with hangers and the plastic member 717 of the series of interconnected rails 703.

The track switch 709 may be designed for inducting products on hangers into the system 701 and may further include a plurality of feeder rails 723, means 724 for selectively joining one of said feeder rails 723 to the series of interconnected rails 703, and a flexible switch arm 725. The flexible switch arm 725 may be configured to allow for the joining of the series of interconnected rails 703 to one of the feeder rails 723. The track switch 709 may be configured so that hangers may be placed on one of the feeder rails 723 and then may be inducted into the series of interconnected rails 703 once the selected feeder rail 723 is joined to the series of interconnected rails 703.

The system may further include an additional track switch 727 that may be designed to facilitate the exit of products on hangers from the system 701. The additional track switch 727 may further include a plurality of exit rails 729, means 731 for selectively joining one of said exit rails 729 to the series of interconnected rails 703, and a flexible switch arm 731. The flexible switch arm 731 may be configured to allow for the joining of the series of interconnected rails 703 to one of the exit rails 729. The additional track switch 727 may be configured so that hangers may travel along the series of interconnected rails 703, arrive at the additional track switch 727 and exit the series of interconnected rails 703 onto one of the exit rails 729 once the selected exit rail 729 is joined to the system of interconnected rails 703.

Another embodiment of the present invention may be a method of transporting products on hangers. The method may include loading products on hangers onto one of a plurality of feeder rails 723 of a track switch 709, the track switch 709 being designed with means 724 to selectively connect one of the plurality of feeder rails 723 to a series of interconnected rails 703. Each rail of the series of interconnected rails 703 may include an elongated member 711 having a base 713 and a top 715 and a plastic member 717 disposed on and joined to the top 715 of the elongated member 711, said plastic member 717 configured to facilitate the movement of the hangers along the length of the plastic member 717. The method may further include actuating the means 724 for selectively connecting one of the plurality of feeder rails 723 to the series of interconnected rails 703, thereby connecting one of the plurality of feeder rails 723 to the series of interconnected rails 703, and thereafter transporting the products on hangers to the series of interconnected rails 703. The method may further include activating a movable train 705, disposed adjacent to the series of interconnected rails 703, and having a pusher dog assembly 707 disposed thereon, the pusher dog assembly 707 extending toward the plastic member 717 of the system of interconnected rails 703. The method may further include engaging the hangers with the pusher dog assembly 707 and pushing the hangers from a first position to a second position along the series of interconnected rails 703. The method may further include transporting said hangers to a point on the series of interconnected rails 703 adjacent to an additional track switch 727, the track switch 727 being designed with means 731 for joining the series of interconnected rails 703 with one of a plurality of exit rails 729. The method may further include actuating the means 731 for joining the series of interconnected rails 703 to one of the plurality of exit rails 729, thereby connecting the series of interconnected rails 703 to one of the plurality of exit rails 729, and transporting said hangers onto one of the plurality of exit rails 729.

What is claimed is:

1. A system for transporting products on hangers, the system comprising:
a series of interconnected rails, each said rail comprising:
an elongated member having a base and a top; and
a plastic member disposed on and joined to the top of the elongated member, said plastic member configured to facilitate the movement of said hangers along the length thereof;
a movable train disposed adjacent to said rails;
a pusher dog assembly, said pusher dog assembly joined to said train and extending toward said plastic member, such that the pusher dog assembly selectively engages said hangers and pushes them from a first position to a second position; and
a track switch joined to said series of interconnected rails, said track switch comprising:
a plurality of feeder rails; and
means for selectively joining one of said feeder rails to said series of interconnected rails.

2. The system of claim 1, wherein the plastic member is formed from a material selected from the group consisting of oil filled ultra-high molecular weight polyethylene and hardened teflon.

3. The system of claim 1, wherein the pusher dog assembly comprises a top end and a bottom end and a pusher pad disposed near the bottom end.

4. The system of claim 3, wherein the pusher pad is formed from a material selected from the group consisting of urethane, polyurethane and glass-filled nylon.

5. The system of claim 3, wherein the pusher pad has a stainless steel tip.

6. The system of claim 1, wherein the track switch further comprises a flexible switch arm, wherein the flexible switch arm connects one of the plurality of feeder rails to the series of interconnected rails.

7. The system of claim 1, wherein the system further comprises an additional track switch joined to said series of interconnected rails, said additional track switch comprising:
a plurality of exit rails; and
means for selectively joining one of said exit rails to said series of interconnected rails.

8. A system for transporting products on hangers, the system comprising:
a rail component comprising:
a metal extrusion having a top surface and a bottom surface; and
a plastic extrusion having a top and a bottom, the bottom of the plastic extrusion being configured to fit over the top surface of the metal extrusion;
an enclosed track having a top and a bottom, and defining a longitudinal slit along the bottom thereof, the enclosed track being disposed above, and running parallel to, the rail component;
a power chain disposed within and running through the enclosed track;
at least one pusher dog assembly, the at least one pusher dog assembly being engaged to the power chain, protruding downward through the slit, and configured to push hangers along the rail component;
at least one track switch, configured to induct products on hangers onto the rail component, and comprising:
an upper plate;
at least two induction sections of rail component;
an exit section of rail component;
at least three support members, each support member joining a respective one of the at least two induction sections of rail component and the exit section of rail component to the upper plate;
a movable section of rail component, joined to the exit section of rail component by a flexible switch arm; and
a switching mechanism, joined to the upper plate and the movable section of rail component, for moving the movable section of rail component into a position adjacent to one of the at least two induction sections of rail component; and
a hook assembly, disposed contiguously to the rail component, designed to mediate the transfer of products on hangers to a further processing step.

9. The system of claim 8, wherein the plastic extrusion is formed from a material selected from the group consisting of oil filled ultra-high molecular weight polyethylene and hardened teflon.

10. The system of claim 8, wherein the plastic extrusion includes an additive that confers UV light resistance on the plastic extrusion.

11. The system of claim 8, further including at least one additional track switch, the at least one additional track switch being configured to facilitate the exit of products on hangers from the system, and comprising:
an upper plate;
an induction section of rail component;
at least two exit sections of rail component;
at least three support members, each support member joining a respective one of the induction section of rail component and the at least two exit sections of rail component to the upper plate;
a movable section of rail component, joined to the induction section of rail component by a flexible switch arm; and
a switching mechanism, joined to the upper plate and the movable section of rail component for moving the movable section of rail component into a position adjacent to one of the at least two exit sections of rail component.

12. The system of claim 8, wherein the flexible switch arm is formed from a material from the group consisting of nylon, polypropylene and rubber.

13. The system of claim 8, wherein the flexible switch arm is designed to facilitate a change in direction of flow of products on hangers in the range of 0-45°.

14. The system of claim 8, wherein the flexible switch arm includes fins, the fins being designed to prevent the jamming of hangers against sections of rail component.

15. A method of transporting products on hangers in a facility, the method comprising the steps of:
loading products on hangers onto one of a plurality of feeder rails of a track switch, said track switch having means to selectively connect one of said plurality of feeder rails to a series of interconnected rails;
actuating said means for selectively connecting one of said plurality of feeder rails to the series of interconnected rails, thereby connecting one of said plurality of feeder rails to the series of interconnected rails;
transporting the products on hangers to the series of interconnected rails;
activating a movable train, disposed adjacent to said series of interconnected rails, having a pusher dog assembly disposed thereon, said pusher dog assembly extending toward said series of interconnected rails;
engaging said hangers with said pusher dog assembly; and
transporting said hangers from a first position to a second position along said series of interconnected rails.

16. The method of claim 15, further comprising the steps of:
transporting said hangers to a point on the series of interconnected rails adjacent to an additional track switch, the track switch having means to selectively connect the series of interconnected rails to one of a plurality of exit rails;
actuating said means for connecting the series of interconnected rails to one of the plurality of exit rails, thereby connecting the series of interconnected rails to one of the plurality of exit rails; and
transporting said hangers onto one of the plurality of exit rails.
